(19) United States
(12) Patent Application Publication
(10) Pub. No.: US 2011/0124255 A1
(43) Pub. Date: May 26, 2011

(54) PERMANENT HYDROPHILIC NONWOVEN

(75) Inventors: Thomas Broch-Nielsen, Aalborg ø (DK); Jens Bøndergaard, Silkeborg (DK); Flemming Besenbacher, Aarhus V (DK); Peter Kingshott, Skanderborg (DK)

(73) Assignee: FIBERTEX A/S, Aalborg Ost (DK)

(21) Appl. No.: 12/952,733

(22) Filed: Nov. 23, 2010

(30) Foreign Application Priority Data
Nov. 24, 2009 (EP) 09 014 637.4

(51) Int. Cl. B32B 27/08; B05D 3/04; B32B 27/12

(52) U.S. Cl. 442/64; 427/538; 442/118

(57) ABSTRACT

The present invention relates to a process for coating a polymer nonwoven comprising the steps of: plasma and/or corona assisted treatment of the surface of the nonwoven to obtain a charged and/or polar surface; and formation of a first coating layer comprising at least one first charged and/or polar species, the first species being a hydrophilic polymer, wherein the overall charge or partial charge facing the nonwoven surface of the first species carries the opposite sign from the average charge introduced to the nonwoven fiber surface in step a).

This invention relates to a process for coating a polymer nonwoven comprising the steps of plasma and/or corona assisted treatment of the surface of the nonwoven to obtain a charged and/or polar surface and formation of a first coating layer comprising at least one first charged and/or polar species, the first species being a polymer, wherein the overall charge or partial charge facing the nonwoven surface of the first species carries the opposite sign from the charge introduced to the nonwoven fiber surface in the first step. The invention also relates to a nonwoven fabric obtainable by said process, as well as to the application of such a nonwoven fabric in disposable hygiene products.

In the state of the art it is common to employ nonwoven fabrics in disposable absorbent articles, especially hygiene articles such as diapers, adult incontinence products and feminine hygiene products. The nonwoven fabrics are preferably employed therein as top sheet material or core wrapping material and assist to collect and retain bodily fluids such as urine deposited in the hygiene article. For these applications in hygiene articles it is sometimes necessary to have a hydrophilic nonwoven, i.e. a nonwoven that is easily permeated by aqueous fluids and/or easily charged therewith. However, commonly used polymer nonwoven fabrics, such as for example polypropylene, polyethylene or polyethyleneterephtalate based ones are hydrophobic.

To address this problem different methods for making the surface of a nonwoven hydrophobic have been developed and are known from the state of the art, one of which being topical treatments such as coatings. Inter alia WO 93/04113 or WO 95/25495 describe such methods. Surface coatings can be based on surfactants that typically present themselves as molecules that are hydrophilic on one and hydrophobic on the other end. When applied to a hydrophobic surface such as the surface of polyolefines they orient themselves with the hydrophobic side facing towards and the hydrophilic side facing away from the surface, causing hydrophilic properties. Current state of the art in topical surface treatment is represented by the application of commercial spin-finishes by kiss roll deposition, sprayin, or similar application processes. Commercial spin-finishes commonly used for nonwovens in hygiene industry include products as Stantex S6327 by Pulcra Chemicals and PHP 90 by Schill & Seilacher.

One drawback of these methods is that the associated surfactants and/or other coatings are easily washed off when the nonwoven is exposed to the liquid. As such liquid strike through values are increased with every gush of liquid the non-woven is exposed to, because the coating substance is not connected to the surface of the nonwoven firmly enough and easily washed off.

Another known method to make the surface of an apolar polymer hydrophilic is post-modification of the surface using corona and plasma treatment, where molecules from the air or another ionizable gas are ionized by an electric field and bind readily with the surface of a polymer like a polyolefin. Corona treatment makes surfaces both hydrophilic and more receptive to bonding with other substances, coatings and adhesives. U.S. Pat. No. 6,118,218 discloses a method for producing plasma suitable for this application. A common disadvantage of corona and plasma treatment is similar to simple surface modification that the molecules grafted to the surface have a tendency to migrate and vanish over time, causing low coating durability upon storage of the material. Hydrophilicity decreases over time. To overcome these disadvantages, EP 1 403 419 suggests to modify at least parts of the fibers used in a nonwoven fabric by chemical grafting with hydrophilic monomer molecules and a radical polymerisation initiator to obtain hydrophilic polymers chemically grafted to the fibers.

State of the art also teaches the addition of hydrophilic additives into the polymer matrix to achieve the desired effect. These additives preferably migrate to the surface of a fiber to donate hydrophilic properties there. Polymers with hydrophilic additives have the disadvantage of being expensive and time-consuming to manufacture. Intrinsically hydrophilic polymers suitable for the manufacture of nonwovens are also known. For example, U.S. Pat. No. 4,163,078, U.S. Pat. No. 4,257,909 and U.S. Pat. No. 4,810,449 disclose hydrophilic filaments of fibers made by solution spinning of acrylonitrile copolymers. However, solution spinning is relatively expensive and requires organic solvents which are a potential environmental hazard. Melt-extruded hydrophilic fibers and filaments are known but normally expensive and uncommon. An example of obtaining melt-extruded mulitcomponent strands to obtain permanently hydrophilic polymer nonwovens is laid out in EP 0 597 224, whereby one of the components is for example a polymer or copolymer formed by hydrophilic monomers or blocks like polyethylene oxide diamine and/or ethylene acrylic acid.

It is desirable to construct nonwovens that are more hydrophilic and permeable towards polar liquids than common polyolefin based hydrophobic polymer nonwovens employing pure polypropylene, polyethylene and/or polyethylene terephtalate (with surface tensions of 29.4 to 30.1 mN/m, 33.7 to 33.8 mN/m, and 44.6 mN/m, respectively [all values from The Polymer Handbook, 4^{th} edition, volume 2, J. Brandrup, E. H. Immergut 1999]) because neither of these can be penetrated by water, whose surface tension is about 72 mN/m. It is also desirable to overcome the drawbacks from the state of the art and being able to cheaply produce coated nonwovens that are more stable towards repeated exposure to liquids by utilizing the strength of polar bonds. This improves (decreases) the strike through time after repeated exposure to liquids in reducing the undesired solvation of surfactants, and also improves shelf life. Such a process should preferably be easily incorporable in a continuous or semicontinuous production environment that does not require expensive starting materials, as such keeping the cost of the overall production low.

One or more of these goals are achieved by employing the process for coating a polymer nonwoven of claim 1. Such a process for coating a preferably hydrophobic polymer nonwoven comprises the steps of
a) plasma and/or corona assisted treatment of the surface of the nonwoven to obtain a charged and/or polar surface; and
b) formation of a first coating layer comprising at least one first charged and/or polar species, wherein the first species is a hydrophilic polymer and wherein the overall charge or partial charge facing the nonwoven surface of the first species carries the opposite sign from the average charge introduced to the nonwoven fiber surface in step a).

Polar bonds between the polymer material of the nonwoven fibers and a polymer coating are consequently introduced. Using polymers as coatings has the advantage of potentially providing multiple binding sides along their stretch. They can hence make coatings more chemically and mechanically stable towards repeated exposure to liquids compared to e.g. surfactants from the state of the art with one or few binding points. The straightforward procedure of corona treatment and simple coating can, however, still be retained and the process can in one embodiment easily and economically be performed semi-continuously or continuously. In another embodiment, also discontinuous use is possible.

A preferable embodiment of the process is described by claim 2. It can further comprises a third step c), being the formation of a second coating layer comprising at least one second charged and/or polar species, wherein the overall charge or partial charge facing the nonwoven surface of the second species carries the same sign from the average charge introduced to the nonwoven fiber surface in step a). As such, the charge of the second species carries the opposite sign from the average charge of the first layer. In a preferred embodiment, also this second species is a polymer.

In one embodiment the process encompasses hence the steps of a) plasma and/or corona assisted treatment of the surface of the nonwoven to obtain a charged and/or polar surface, b) formation of a first coating layer comprising at least one first charged and/or polar species, wherein the overall charge or partial charge facing the nonwoven surface of the first species carries the opposite sign from the average charge introduced to the nonwoven fiber surface in step a), and c) formation of a second coating layer comprising at least one second charged and/or polar species, wherein the overall charge or partial charge facing the nonwoven surface of the second species carries the same sign from the average charge introduced to the nonwoven fiber surface in step a), wherein the first species of step b) and the second species of step c) are polymers.

The above layers can also consist of the first and second species, respectively, or to a large part consist of said species. A large part means in this context that the coating comprises at least 50% by weight, preferably at least 65% by weight, or even more preferably at least 80% by weight of said species. Other components can comprise other charged polymeric and/or non polymeric molecules, uncharged molecules and other wanted or unwanted contaminants and additives. Instead of a “first charged species” and/or a “second charged species” also mixtures of different species that meet the respective definitions can be utilized.

A further preferred embodiment is laid out in claim 3. Therein, steps b) and c) are repeatedly carried out and can form a number of layers of opposite average intrinsic charge, meaning that the average charge of one layer has the opposite sign of the average charge of the two surrounding layers. If every step produces one layer, a number N of layers is obtained. N may be 1 or 2 as in the embodiments above, but can also adopt values higher than these. Depending on the surface, the parameters of the corona treatments and the nature and concentration of the first and second species, there may be different optimum values for N and different optimum ranges for N, which lead to the best performance in one or more of the above-identified targets like in one embodiment increased stability, and in another embodiment water retention/water permeable capabilities, or which constitute the best compromise between production cost and performance for a certain application. In one other embodiment the beneficial effect from adding more layers continues up to a certain point and diminishes in effect before that. As such, the process of applying the coating can be an N step layer-by-layer process in which prior to the first step corona and/or plasma assisted creation of charged chemical species on the polymer is required.

In another embodiment as described in claim 4, the process can further comprise one or more intermediate and/or terminal washing steps d), wherein an excess amount of charged species is washed off one or more N^{th} first and/or second layers after their formation. A washing step may be applied after the first formation of a first layer (N=1), or only after a first formation of the second layer (N=2), or between formation of any first and second layer, after formation of every layer, or only when finishing off to the outermost layer. The number of washing steps may be as high as N or lower than N, preferably N/2 or N−1. This optional washing step of excess charged polymer can reduce the thickness of the washed layer(s) and can reduce the amount of any non-specifically bonded species, preferably polymer species. This can especially be advantageous when washing off a layer before the application of a next layer, because it can reduce the possibility of unstable interfaces with subsequent layers.

Polar and/or charged surface chemical species are utilized for coating the corona treated nonwovens in order to form electrostatic bonds between the polar/charged nonwoven surface groups and the coating polymers with opposite polarity/charge and between different coating polymers with opposite polarity/charge. Polar/electrostatic binding of coatings to the nonwovensurface and subsequent polar/electrostatic binding between individual layers can result in a more stable and permanent coating as compared to previous technologies. This can improve (decrease) the strike through time after repeated insults with liquid and reduce the wash-out. By reducing the wash-out, e.g. the amount of washed-off coating in contact with skin ant other surrounding materials is reduced.

Another preferred embodiment is laid out in claim 5. In this embodiment, a layer is formed by application of a liquid solution of positively or negatively charged synthetic or natural polymers by means of corona and/or plasma treatment physically and/or chemically modified surface of the nonwoven. One or more of kiss roll deposition, spray techniques, immersion techniques or other techniques suitable to apply solution to a nonwoven sheet can be used. In a preferred embodiment, kiss roll deposition is employed. In another preferred embodiment the formation of a layer is followed by evaporation of the solvents. Preferred solvents for the application include water, methanol, ethanol and other alcohols, acetone, DMSO and other non-protic polar organic solvents like acetylacetate and other esters, different ethers, as well as combinations thereof.

In all the embodiments herein, all species, preferably polymeric, carrying at least one positive charge sign or at least one positive partial charge are suitable for the use as a “positive species”. All species, preferably polymeric, carrying at least one negative charge sign or at least one negative partial charge are suitable for the use as a “negative species”.

One preferred layering array is described in claim 6. In this embodiment the plasma and/or corona assisted treatment of the nonwoven fiber surface results in average in a negatively charged surface. Consequently, the first species employed in step b) to form the first layer and optionally more layers, all with an uneven value of N, is a positive species and the second species employed in step c) to optionally form a second or more layers, all with an even value of N, is a negative species. In this preferred embodiment the process is hence an N step layer-by-layer process following a corona and/or plasma assisted creation of a negatively charged and/or polar chemical surface species on the nonwoven polymer fibers.

One possible layering array is described in claim 7. In this embodiment the plasma and/or corona assisted treatment of the nonwoven fiber surface results in average in a positively charged fiber surface. Consequently, the first species employed in step b) to form the first layer and optionally more layers, all with an uneven value of N, is a negative species and the second species employed in step c) to optionally form a second or more layers, all with an even value of N, is a positive species.

Preferably, the positive species is a polymer species. Polymers suitable for use as a positive species are described in claim 8. As such, they include natural and/or synthetic polymers, preferably one or more of the synthetic polymer species selected from the group poly(acrylamide-co-diallyldimethylammonium chloride), poly(diallyldimethylammoniumchloride) poly(allylamine), poly(dimethylamine-coepichlorohydrin-co-ethylenediamine), poly(lysine), poly(vinylamine) and/or one or more of the natural polymer species selected from the group chitosan, aminodextran, amino-cellulose, amino-alginate, amino-starch, amino-xanthan, quarternized amino functionalised carbohydrate based polymers. In general, any synthetic or natural polymer containing chemical functional groups that have the potential to form positive charges, as well as conjugates of natural and synthetic polymers with such properties may be employed. In one specifically preferred embodiment, the positive species is poly(acrylamide-co-diallyldimethylammonium chloride).

Preferably, the negatively charged species is a polymer species. Polymers suitable for use as a negatively charged species are described in claim 9. As such, they include natural and/or synthetic polymers, preferably one or more of the synthetic polymer species selected from the group poly(vinylsulfate), poly(2-acrylamido-2-methyl-1-propanesulfonic acid), poly(acrylic acid) or any polymers containing negatively charged chemical groups such as acids, sulfates, sulfonates, nitrates, or nitrosyl, or hydrophilic polar residues and/or one or more of the natural polymer species selected from the group dextran sulphate, dermatin sulphate, alginic acid, chondroitin sulphate, hyaluronic acid, carboxymethyl cellulose, carboxymethyl dextran, or any polymers containing negatively charged chemical groups such as acids, sulfates, sulfonates, nitrates, or nitrosyl, or hydrophilic polar residues. In general, any synthetic or natural polymer containing chemical functional groups that have the potential to form negative charges, as well as conjugates of natural and synthetic polymers with such properties may be employed. In one specifically preferred embodiment, the negative species is poly(2-acrylamido-2-methyl-1-propanesulfonic acid).

Nonwoven fabrics suitable for treatment with the process of the above embodiments can comprise or consist of nonwoven fibers made from any polymer common in the art, which has hydrophobic or only slightly hydrophilic properties. In one embodiment the nonwoven comprise or consist of thermoplastic polymers, including polymer compositions, mixtures and blends. Examples of suitable thermoplastic polymers for the use herein are described in claim 10. They include polyolefins, preferably polypropylene or polyethylene or further polyethylene-polypropylene copolymers; polyesters, polyamides; polyhydroxyalkanoates, and mixtures thereof. The fibres may also be multicomponent fibres, including bicomponent fibres. In one embodiment, polypropylene and polypropylene compositions are preferred, including homopolymers and copolymers of propylene. One preferred polymer material is polypropylene linked with the help of a metallocene catalyst. Such metallocenepolypropylene polymers offer a much greater level of control than conservative polypropylene materials that are connected with the help of a Ziegler-Natta catalyst, because the metallocene molecules offer better control towards how the monomers are linked, so that a proper choice of catalysts can produce isotactic, syndiotactic or atactic polypropylene, or even a combination of these.

In one specifically preferred embodiment, suitable materials for the nonwoven to be coated are selected from one or more of polyethylene, polypropylene, or polyethyleneterephtalate.

In one embodiment of the invention a suitable nonwoven for coating is manufactured by spunbound/meltblown layering of only one or more spunbound (S) layers and/or one or more meltblown (M) layers, e.g. in an SMMMS, SMMS or SSMMS configuration, and other configurations known to the skilled person.

In another embodiment of the invention a suitable nonwoven for coating is manufactured by spunbound/meltblown layering of only one or more spunbound (S) layers, e.g. in a S, SS or SSS configuration, and other configurations known to the skilled person.

The fibres the nonwoven fabrics or layers in more-layered fabrics herein can in one embodiment be nanofibers, with a diameter of less than 1000 nanometers, or in another embodiment be fibers with a diameter of more than a micrometer, in a yet another embodiment of more than 10 micrometers, or combinations thereof. Alternatively, or in addition, a nonwoven herein may for example comprise or consist of one or more spunbond layers from fibers with an average fiber diameter of, for example, from 6 to 22 microns, or from 8 to 18 microns. The meltblown web or layer herein may for example comprise or consist of one or more meltblown layers from fibers that have an average fiber diameter from 1 to 5 microns, or 1 to 4 microns, or preferably from 1 to 3 microns, or less than 1 micron. Fiber diameters expressed hereinabove for meltblown layers and spunbound layers are interchangeable.

A representative suitable nonwoven template can be made of standard polypropylene and have an area weight of between about 5 and about 20 g/m², preferably between about 8 and about 15 g/m².

In one embodiment the corona and/or plasma treatment is performed in an optimum energy range to prepare the surface in an optimized way for subsequent application and binding of coating layer(s). The existence of such a window of optimum corona effect is well known within the industry. In one embodiment, the preferred corona energy is between about 7 and about 13 kJ/m², in another embodiment between about 1 kJ/m² and about 7 kJ/m². The speed with which the nonwoven passes the corona discharge is in one embodiment preferably between 1 m/min and 100 m/min. In another embodiment, the speed with which the nonwoven passes the corona discharge is between 100 m/min and 200 m/min. In yet another embodiment, the speed with which the nonwoven passes the corona discharge is between 200 m/min and 500 m/min. A preferred embodiment of these settings is laid out in claim 11. However, all numerical values largely depend on the nonwoven material, the nonwoven makeshift and the nonwoven area weight, as well as from the method of coating, the nature of the coating species, the mode of appliance and other parameters. As such, deviations from the above values are to be expected for some applications.

All the steps mentioned in the foregoing embodiments can be carried out in a discontinuous, a semicontinuous, or preferably a continuous manner. In an especially preferred embodiment, the steps of plasma and/or corona assisted treatment of the nonwoven fiber surface to introduce charged polar surface species and application of first charged species, and optionally steps c) and/or d) are carried out in a continuous manner on line.

The present invention further relates to a nonwoven fabric as of claim 12. Such a nonwoven is obtainable by the process described hereinabove. It comprises one or more polymer coating layers bound by multiple polar bonds and has an increased surface tension relative to standard nonwoven. This results in an easy break through of aqueous liquids as for example urine through a nonwoven web.

In one embodiment the nonwoven will maintain low strike through values even at a large number of test in a repeated liquid strike through test. As such, the LST can increase by less than 30% after 5, preferably 10, more preferably 20, most preferably 50 insults, in a preferred embodiment by less than 20% or less than 15%, in yet another preferred embodiment by less than 10%, in an especially preferred embodiment by less than 5% and in one most preferred embodiment by less than 1% or even less than 0.5%. A preferred embodiment of these properties is given in claim 14. In one embodiment, the liquid strike through of a representative 10 g/m² SMMMS PP nonwoven (4.4 g/0.4 g/0.4 g/0.4 g/4.4 g) may be less than 7 seconds after 20, preferably 50 gushes, in another embodiment less than 5 seconds after 20, preferably 50 gushes and in an even preferred embodiment less than 3 seconds after 20, preferably gushes. In stark contrast, when using standard finishes a steep increase in values after about 3 to 5 tests is to be expected.

The present invention also relates to an application as of claim 15. As such, it relates to the application of a nonwoven fabric obtainable by a process according to the invention in a disposable hygiene product. Preferred disposable hygiene products encompass baby diapers, adult incontinence products and feminine hygiene products. In such products, the nonwoven fabric produced by the method according to the present invention may preferably be employed as a top sheet and/or a wrap material.

The following test methods are used to obtain the numerical values set forth in the above description as well as in the claims of this patent application.

### Repeated Strike Through Test:

The standardized test method EDANA/INDA test WSP 70.7 (05) for nonwoven cover stock multiple liquid strike through time using simulated urine was used. In order to increase the number of repeated insults above 5, the filter paper was changed for every 5 insults, e.g. before insult 6, 11, 16, 21 etc.

In the examples, where some values for LST are indicated for a number of repetitions (such as 11 to 20), the value represents the average LST for the respective number of repetitions.

The following examples are set forth for the purpose of illustrating the invention in more detail.

### COMPARATIVE EXAMPLE

As a comparative example a 10 g/m² spunbound/meltblown SMMMS (4.4 g/0.4 g/0.4 g/0.4 g/4.4 g) polypropylene nonwoven was coated with standard spin-finish (PHP26, Schill & Seilacher) at 100 m/min to obtain a standard core wrap nonwoven. As such, the comparative example corresponds to a nonwoven fabric coated to become hydrophilic as of the state of the art.

### Example 1

The surface of a 10 g/m² spunbound/meltblown SMMMS (4.4 g/0.4 g/0.4 g 10.4 g/4.4 g) polypropylene nonwoven was physically and chemically modified by corona treatment. The corona energy was set to 4.8 kJ/m² and the speed of the nonwoven through the corona discharge was 100 m/min. The chemical modification therein consists essentially of the addition of polar surface species such as hydroxyl, carboxyl, epoxy and aldehyde groups to the surface of the fibers of the PP nonwoven.

The resulting nonwoven without further treatment corresponds to a corona and plasma treated nonwoven fabric from the state of the art.

### Example 2

The corona treated polypropylene nonwoven of example 1 is used as a basis for binding of positively charged polymers to the nonwoven. Coating with a single layer of positively charged poly(acrylamide-co-diallyldimethylammonium chloride) is achieved through 100 m/min kiss roll deposition of a 10 mg/ml solution of this polymer in water.

The deposition step is immediately followed by baking for 5 seconds at 100° C. in an oven. After baking, the nonwoven is dry and hydrophilic. The obtained nonwoven bears one layer of positively charged polymer coating, bound on multiple sides through polar bonds. It has in one case been stored for 4 days before measurement, and in another case for 25 days in order to simulate storage of the product before being commercially sold.

### Example 3

The dry, singly coated nonwoven of example 2 before storage is used as a base material for a coated nonwoven of example 3. The process of example one is immediately followed by 100 m/min kiss roll deposition of a 10 mg/ml solution of poly(2-acrylamido-2-methyl-1-propanesulfonicacid) in water before being heated for seconds at 100° C., after which the nonwoven is dry and hydrophilic.

The obtained nonwoven bears one layer of positively charged polymer coating and one layer of negatively charged polymer coating, bound and interconnected on multiple sides through polar bonds. It has in one case been stored for 4 days before measurement, and in another case for 25 days in order to simulate storage of the product before being commercially sold.

### Example 4

Example 4 differs from example 3 in that before the heating step one washing step with pure water was performed. For this purpose, the nonwoven was simply rinsed with an access amount of water on line before dried under the same conditions.

Repeated strike through tests of the comparative example (10 g/m² SMMMS with standard hydrophilic spin-finish) and the single coated nonwoven of example 2 both after 4 days aging and 25 days aging have been carried out. The results are shown in Table 1.

TABLE 1
Comparison of LST of corona reference with single layer coatings and standard
10 g/m² SMMMS with standard hydrophilic spinfinish. Numbers are in seconds.

| | insult number | | | | | | | | | | |
|---|---|---|---|---|---|---|---|---|---|---|---|
| Sample | 1 | 2 | 3 | 4 | 5 | 6 | 7 | 8 | 9 | 10 | 11-20 |
| Comp. ex. | 1.4 | 2.3 | 3.5 | 2.7 | 2.6 | 4.6 | 7.6 | 7.7 | 5.2 | 6.5 | 7.4 |
| Example 2 (4 days) | 32.4 | 22.0 | 15.8 | 13.1 | 11.5 | 9.2 | 7.4 | 7.8 | 5.9 | 5.3 | — |
| Example 2 (25 days) | 22.1 | 11.6 | 10.3 | 8.7 | 8.7 | 12.2 | 8.4 | 9.3 | 8.2 | 7.3 | 3.7 |

While the conservatively coated nonwoven of the comparative example shows a significant increase in strike through times after the increasing number of liquid insults, the nonwovens of example 2 show a continuous decrease in strike through times. The desirable effect achieved by means of the process presented hereinabove is clearly proved by example 1, where the averaged strike through time between 11 and 20 liquid insults is as low as 3.7 seconds for a nonwoven aged 25 days after coating. It can be concluded that no or only insignificant parts of the coating material has been dissolved in the insulting liquid.

For further comparison, the LST values for examples 3 and 4 are shown in Table 2:

TABLE 2

| | insult number | | | | | | | | | | |
|---|---|---|---|---|---|---|---|---|---|---|---|
| Sample | 1 | 2 | 3 | 4 | 5 | 6 | 7 | 8 | 9 | 10 | 11-20 |
| Example 3 | 2.1 | 2.6 | 2.4 | 2.8 | 2.6 | 2.2 | 2.5 | 2.5 | 2.4 | 2.5 | — |
| (4 days) | | | | | | | | | | | |
| Example 3 | 5.5 | 3.1 | 2.7 | 2.7 | 2.4 | 2.2 | 2.6 | 2.3 | 2.2 | 2.2 | — |
| (4 days) | | | | | | | | | | | |
| Example 4 | 2.3 | 2.1 | 2.0 | 1.8 | 1.6 | 1.5 | 1.8 | 1.8 | 1.7 | 1.6 | 1.7 |
| (25 days) | | | | | | | | | | | |
| Example 4 | 3.1 | 2.3 | 2.2 | 1.8 | 1.7 | 1.6 | 2.0 | 1.7 | 1.8 | 1.5 | 1.8 |
| (25 days) | | | | | | | | | | | |

From Table 2 it becomes apparent that double coating improves the strike through values right from the start. These excellent strike through times stay about constant after 20 insults. Also, terminal washing and aging does not significantly influence the properties of the coating. A terminally washed double coated layer (example 3) even shows slightly lower strike through times than the corresponding non-washed double coated layer (example 2). As above, no or only insignificant parts of the coating material are suspected to have been dissolved in the insulting liquid.

### Example 4

In this example a nonwoven is corona treated and coated in an inline continuous process.

The surface of a 10 g/m² spunbond/meltblown SMMMS polypropylene nonwoven was physically and chemically modified by corona treatment. Four different settings were used (A, B, C, D).

| | Corona effect | Speed | Weight | Drying time |
|---|---|---|---|---|
| Setting nr. | [kJ/m²] | [m/min] | [g/m²] | [s] |
| A | 4.8 | 100 | 0.1 | 4.8 |
| B | 9.6 | 50 | 0.055 | 9.6 |
| C | 9.6 | 50 | 0.35 | 9.6 |
| D | 2.4 | 200 | 0.22 | 2.4 |

The chemical modification in all cases consists essentially of the addition of polar surface species such as hydroxyl, carboxyl, epoxy and aldehyde groups to the surface of the fibers of the PP nonwoven.

The corona treated polypropylene nonwoven was then immediately (inline) used as a basis for binding of positively charged polymers to the nonwoven. Coating with a single layer of positively charged poly(acrylamide-co-diallyldimethylammonium chloride) was achieved through kiss roll deposition of a 40 mg/ml solution of this polymer in water.

The deposition step was immediately followed by drying at 100° C. in an oven. After drying, the nonwoven is dry and hydrophilic. The obtained nonwoven bears one layer of positively charged polymer coating, bound on multiple sides through polar bonds.

### Results:

Coated nonvowens were tested using the repeated liquid strike-through test with 50 repetitions. There were no obvious decrease or increase in strike-through time over the cause of the 50 measurements.

Strikethrough data from sample A, B, C, and D are shown in Table 4. Corona references without coating are also shown for each sample.

TABLE 4
The repeated strike-through data in seconds.

| | insult number | | | | | | | | | |
|---|---|---|---|---|---|---|---|---|---|---|
| Sample | 1 | 2 | 3 | 4 | 5 | 6-10 | 11-20 | 21-30 | 31-40 | 41-50 |
| Corona reference, A | >100 | — | — | — | — | — | — | — | — | — |
| Coated sample, A | 5.1 | 2.7 | 2.6 | 2.2 | 2.0 | 2.2 | 2.1 | 2.0 | 2.1 | 2.2 |
| Corona reference, B | >100 | — | — | — | — | — | — | — | — | — |
| Coated sample, B | 2.6 | 2.5 | 2.5 | 2.4 | 2.2 | 2.5 | 2.2 | 2.4 | 2.3 | 2.6 |
| Corona reference, C | >100 | — | — | — | — | — | — | — | — | — |
| Coated sample, C | 1.5 | 2.1 | 2.0 | 2.0 | 1.8 | 2.1 | 2.2 | 2.1 | 2.3 | 2.1 |
| Corona reference, D | >100 | — | — | — | — | — | — | — | — | — |
| Coated sample, D | 3.7 | 3.7 | 3.4 | 3.1 | 2.7 | 3.1 | 3.1 | 3.2 | 3.0 | 3.2 |

### Example 5

In this example a nonwoven is corona treated and coated in an inline continuous process.

The surface of a 15 g/m² spunbond SSS polypropylene nonwoven was physically and chemically modified by corona treatment. The corona energy was set to 4.80 kJ/m² and the speed of the nonwoven through the corona discharge was 100 m/min. The chemical modification therein consists essentially of the addition of polar surface species such as hydroxyl, carboxyl, epoxy and aldehyde groups to the surface of the fibers of the PP nonwoven.

The corona treated polypropylene nonwoven was then immediately (inline) used as a basis for binding of positively charged polymers to the nonwoven. Coating with a single layer of positively charged poly(acrylamide-co-diallyldimethylammonium chloride) was achieved through 100 m/min kiss roll deposition of a 40 mg/ml solution of this polymer in water. The weight of coating was 0.22 g/m².

The deposition step was immediately followed by drying for approximately 2.4 seconds at 100° C. in an oven. After drying, the nonwoven is dry and hydrophilic. The obtained nonwoven bears one layer of positively charged polymer coating, bound on multiple sites through polar bonds.

### Results:

Coated nonvowens were tested using the repeated liquid strike-through test with 50 repetitions. There were no obvious decrease or increase in strike-through time over the cause of the 50 measurements.

TABLE 5
The repeated strike-through data in seconds.
Corona reference strike through times were only
measured to 10 insults.

| | insult number | | | | | | | | | |
|---|---|---|---|---|---|---|---|---|---|---|
| Sample | 1 | 2 | 3 | 4 | 5 | 6-10 | 11-20 | 21-30 | 31-40 | 41-50 |
| Corona | 8.0 | 5.2 | 6.1 | 6.2 | 5.5 | 7.22 | — | — | — | — |
| reference | | | | | | | | | | |
| Coated | 3.1 | 3.5 | 3.8 | 4.2 | 2.7 | 3.4 | 3.3 | 3.2 | 3.1 | 3.1 |
| sample | | | | | | | | | | |

1. A process for coating a polymer nonwoven comprising the steps of:
a) plasma and/or corona assisted treatment of the surface of the nonwoven to obtain a charged and/or polar surface; and
b) formation of a first coating layer comprising at least one first charged and/or polar species, the first species being a hydrophilic polymer, wherein the overall charge or partial charge facing the nonwoven surface of the first species carries the opposite sign from the average charge introduced to the nonwoven fiber surface in step a).

2. The process of claim 1, further comprising a third step c) being the formation of a second coating layer comprising at least one second charged and/or polar species, wherein the overall charge or partial charge facing the nonwoven surface of the second species carries the same sign from the average charge introduced to the nonwoven fiber surface in step a), wherein the second species is preferably a hydrophilic polymer.

3. The process of claim 2, wherein steps b) and c) are repeatedly carried out to form a number N of layers of opposite intrinsic charge.

4. The process of claim 3, further comprising one or more intermediate and/or terminal washing steps, wherein an excess amount of charged species is washed off a layer after its formation.

5. The process of claim 1, wherein the first and/or the second species are applied as a liquid solution thereof, preferably followed by evaporation of the solvent.

6. The process of claim 1, wherein plasma and/or corona assisted treatment of the nonwoven fiber surface results in average in a negatively charged surface, the first species is a positive species and the second species is a negative species.

7. The process of claim 1, wherein plasma and/or corona assisted treatment of the nonwoven fiber surface results in average in a positively charged surface, the first species is a negative species and the second species is a positive species.

8. The process of claim 6, wherein the positive species comprise one or more of synthetic polymer species selected from the group poly(acrylamide-co-diallyldimethylammonium chloride), poly(diallyldimethylammonium chloride)poly(allylamine), poly(dimethylamine-co-epichlorohydrin-co-ethylenediamine), poly(lysine), poly(vinyl amine) and/or natural polymer species selected from the group chitosan, amino-dextran, amino-cellulose, amino-alginate, amino-starch, amino-xanthan and quarternized amino functionalised carbohydrate based polymers.

9. The process of claim 6, wherein the negative species comprise one or more of synthetic polymer species selected from the group poly(vinyl sulfate), poly(2-acrylamido-2-methyl-1-propanesulfonic acid), poly(acrylic acid) and/or natural polymer species selected from the group dextran sulphate, dermatin sulphate, alginic acid, chondroitin sulphate, hyaluronic acid, carboxymethyl cellulose and carboxymethyl dextran.

10. The process of claim 1, wherein the nonwoven fibers are made from one or more polyolefins, preferably selected from PET, PP and PE.

11. The process of claim 1, wherein the treatment of the nonwoven fiber surface is a corona treatment, whereby the corona energy is between 1 kJ/m² and 13 kJ/m² and the speed of the nonwoven through the corona discharge is between 1 m/min and 1000 m/min.

12. A nonwoven fabric obtainable by the process of claim 1, wherein the nonwoven comprises one or more polymer coating layers bound by multiple polar bonds and wherein the nonwoven fabric preferably has an average 40^{th} to 50^{th} m) repeated liquid strike through value below 10 seconds (EDANA/INDA test WSP 70.7-05).

13. The nonwoven fabric of claim 12, wherein the nonwoven comprises at least two polymer coating layers.

14. The nonwoven fabric of claim 12, wherein the liquid strike through time of the nonwoven increases by less than 15% after 50 insults in a repeated liquid strike through test (EDANA/INDA test WSP 70.7-05).

15. Application of a nonwoven fabric according to claim 12 in a disposable hygiene product, preferably in baby diapers, adult incontinence products and/or feminine hygiene products, preferably as topsheet and/or wrap material.

16. The process of claim 7, wherein the positive species comprise one or more of synthetic polymer species selected from the group poly(acrylamide-co-diallyldimethylammonium chloride), poly(diallyldimethylammonium chloride)poly(allylamine), poly(dimethylamine-co-epichlorohydrin-co-ethylenediamine), poly(lysine), poly(vinyl amine) and/or natural polymer species selected from the group chitosan, amino-dextran, amino-cellulose, amino-alginate, amino-starch, amino-xanthan and quarternized amino functionalised carbohydrate based polymers.

17. The process of claim 7, wherein the negative species comprise one or more of synthetic polymer species selected from the group poly(vinyl sulfate), poly(2-acrylamido-2-methyl-1-propanesulfonic acid), poly(acrylic acid) and/or natural polymer species selected from the group dextran sulphate, dermatin sulphate, alginic acid, chondroitin sulphate, hyaluronic acid, carboxymethyl cellulose and carboxymethyl dextran.
